(19) United States
(12) Patent Application Publication
(10) Pub. No.: US 2026/0340923 A1
(43) Pub. Date: Oct. 29, 2026

(54) AUTO ASSIGNING FRAME DURATION

(71) Applicant: ADOBE INC., SAN JOSE, CA (US)

(72) Inventors: Nishant Kumar, Greater Noida (IN); Ankur Agarwal, Noida (IN); Medha Sharma, New Delhi (IN); Tanya Garg, New Delhi (IN)

(21) Appl. No.: 19/188,854

(22) Filed: Apr. 24, 2025

(51) Int. Cl. G06T 13/80

(52) U.S. Cl. CPC G06T 13/80; G06T 2200/24; G06T 2210/32

(57) ABSTRACT

A method, apparatus, non-transitory computer readable medium, and system for media generation include obtaining a set of media content items and identifying a content type of a media content item of the set of media content items. A duration for the media content item is computed based on the content type. A media file including the set of media content items is generated. The media file comprises the media content item with the computed duration.

### BACKGROUND

The following relates generally to media processing. Media processing refers to the use of a computer to analyze, modify and enhance various forms of media, such as images, audio, and video. It involves tasks such as compression, encoding, filtering, enhancement, recognition, and conversion to make media suitable for storage, transmission, or playback. Media processing is a combination of natural language processing (NLP) and image processing. Image processing is a type of data processing that involves manipulating or generating image data.

Digital image processing refers to the use of a computer to edit a digital image using an algorithm or a processing network. In some cases, image processing software can be used for various tasks, such as image editing, image restoration, image generation, etc. Recently, machine learning models have been used in advanced media processing techniques.

### SUMMARY

The present disclosure relates to systems and methods for media processing. Embodiments of the present disclosure automatically assign a custom duration (e.g., a length of time) to each of a set of media content items in a media editing process, based on a target duration for a desired media output. The media processing apparatus generates a media file based on the assigned durations. In some examples, the media processing apparatus receives a set of media content items (e.g., static images, GIFs, video clips, animations, text, or a combination thereof) as input. The media processing apparatus automatically assigns durations to each of the media content items. Accordingly, no manual adjustment for the media content items is needed on users' part.

A method, apparatus, non-transitory computer readable medium, and system for media processing are described. One or more embodiments of the method, apparatus, non-transitory computer readable medium, and system include obtaining a set of media content items; identifying a content type of a media content item of the set of media content items; computing a duration for the media content item based on the content type; and generating a media file including the set of media content items, wherein the media file comprises the media content item with the computed duration.

A method, apparatus, non-transitory computer readable medium, and system for media processing are described. One or more embodiments of the method, apparatus, non-transitory computer readable medium, and system include obtaining a set of media content items including an animated content item and a static content item; determining a first duration of the animated content item; computing a second duration of the static content item based on the first duration; and generating a media file, wherein the media file comprises the animated content item with the first duration and the static content item with the second duration.

An apparatus, system, and method for media processing are described. One or more embodiments of the apparatus, system, and method include a memory component; a processing device coupled to the memory component, the processing device configured to perform operations comprising; obtaining a set of media content items; identifying a content type of a media content item of the set of media content items; computing a duration for the media content item based on the content type; and generating a media file including the set of media content items, wherein the media file comprises the media content item with the computed duration.

### BRIEF DESCRIPTION OF THE DRAWINGS

FIG. 1 shows an example of a media processing system according to aspects of the present disclosure.

FIG. 2 shows an example of a method for media generation according to aspects of the present disclosure.

FIG. 3 shows an example of a user interface for the media processing system according to aspects of the present disclosure.

FIG. 4 shows an example of a user interface including a set of media content items according to aspects of the present disclosure.

FIG. 5 shows an example of a user interface for editing a media content item according to aspects of the present disclosure.

FIG. 6 shows an example of a user interface including animated elements with text elements according to aspects of the present disclosure.

FIG. 7 shows an example of a user interface including duration propagation according to aspects of the present disclosure.

FIG. 8 shows an example of a user interface including auto-assign duration before auto-assign according to aspects of the present disclosure.

FIG. 9 shows an example of a user interface including auto-assign duration after auto-assign according to aspects of the present disclosure.

FIG. 10 shows an example of a user interface including filter effects according to aspects of the present disclosure.

FIG. 11 shows an example of a user interface including auto-assigning duration according to aspects of the present disclosure.

FIG. 12 shows an example of a method for media processing according to aspects of the present disclosure.

FIG. 13 shows an example of a media processing apparatus according to aspects of the present disclosure.

FIG. 14 shows an example of a method for media processing according to aspects of the present disclosure.

FIG. 15 shows an example of a method for media processing according to aspects of the present disclosure.

FIG. 16 shows an example of a method for media processing according to aspects of the present disclosure.

FIG. 17 shows an example of a computing device for media processing according to aspects of the present disclosure.

### DETAILED DESCRIPTION

The present disclosure relates to systems and methods for media processing. Embodiments of the present disclosure automatically assign a custom duration (e.g., a length of time) to each of a set of media content items in a media editing process, based on a target duration for a desired media output. The media processing apparatus generates a media file based on the assigned durations. In some examples, the media processing apparatus receives a set of media content items (e.g., static images, GIFs, video clips, animations, text, or a combination thereof) as input. The media processing apparatus automatically assigns durations to each of the media content items. Accordingly, no manual adjustment for the media content items is needed on users' part.

In some examples, the media content items include animated content. In some examples, the pre-determined duration for the final media output is specified through a user selection (e.g., due to length requirement imposed by a media platform). The user wants to emphasize one or more media content items such that these media content items corresponding to a certain content type are assigned a longer duration. Hence, the media processing system automatically assigns the durations based on the user's selection, target length and content type for the media content items.

Conventional methods require users to manually set a duration for each of the media content items. For example, if a user wants a final media output to display five static images, one animated text element, and one animated image, the user needs to specify a duration individually for the five static images, the one animated text element, and the one animated image. The final media output needs to comply with a platform's preferred duration (e.g., 10 s, 15 s, 20 s, or 30 s, in total length). The user has to calculate and assign a duration (e.g., a length of display time) to each of the five static images, the one animated text element, and the one animated image. This is time-consuming and may lead to calculation errors.

In some cases, conventional systems adopt a uniform duration and assign the uniform duration to each of the media content items. These systems fail to adjust the length of time to obtain a custom length for certain important media items (e.g., the user really wants to showcase the one animated text element, and the one animated image). But conventional systems treat all media content items equally and fail to assign a longer duration for important media content items corresponding to a certain content type. Users lack control over the length of duration for each frame in the final media output.

Media editing involves video creation and editing, e.g., adjusting a frame duration in a video clip. Frame editing requires manual adjustment from users. For media platforms such as Instagram® reels, YouTube® shorts, TikTok® and other social media platforms, the final duration of an uploaded media is pre-determined (e.g., 10 s, 15 s, 20 s or 30 s). Adjusting individual frame duration of media content items to comply with the pre-determined duration is labor intensive and time-consuming.

Embodiments of the present disclosure include a media processing apparatus that takes a set of media content items as inputs and computes a duration for each of the media content items. The media processing apparatus generates an output media file based on the computed (and assigned) durations. The duration is calculated based on weighting, where each media content item is assigned a weight corresponding to the content type. The media processing apparatus ensures that the total length of the output media file complies with a predetermined maximum output duration. For example, certain multi-media platforms set a maximum length requirement for uploading videos. The media processing apparatus enables an automated and efficient process of assigning durations for media content items, eliminating user involvement and increasing user satisfaction.

In some embodiments, the media processing apparatus automatically assigns a duration to each of a set of input images based on the type of content. The content type may include image only, image plus text (text element can be static or animated), image plus graphic (graphic element can static or animated), any combination thereof. In some cases, animated text elements and animated graphics are available to users in the form of presets which have a predefined duration of 3 s, 6 s or 9 s. Herein, 3 s is short for 3 seconds.

The media processing model begins with preset selection. Users have the option to choose a preset for output media file such as YouTube® shorts, Instagram® reels etc. Based on the selected preset, the media processing apparatus receives the maximum output duration T_{Max}, such as 90 sec for Instagram® reels.

The media processing model identifies frames with animated text or animated graphics. For these types of frames, the media processing model would not modify the user-selected content by trimming/duplicating it or by changing the frame rate of animated content. Frame duration is automatically determined by the duration of the preset as described below. In some examples, let T_{Animated} be the total time of all animated contents (e.g., text, graphics) applied on the frames. If the maximum output duration T_{Max} is less than T_{Animated}, the media processing model trims the animation to the maximum duration possible T_{Max} and alerts the user about not being able to fit the final output within the stipulated threshold.

The media processing model identifies frames with static content. If the maximum output duration T_{Max} is more than T_{Animated}, part of the remaining time (T_{Static}=T_{Max}−T_{Animated}) is then assigned to static content (e.g., images, graphics, text) as follows. Each of the frames (input image) is assigned an initial weight of 1.0. Each of the other input types (graphics, text) are then assigned heuristically determined weights. Let w_{Graphic}=0.5, w_{Text}=1 be weights for graphics and text, respectively. Weight for each of the frames is then calculated on the basis of what all a frame contains. For example, if a frame includes two graphics and one text layer on top of the image, the media processing model computes an additional weight of (2*w_{Graphic})+w_{Text}. A frame with only an image is assigned the minimum weight=1.0. Let W_{Total} be the accumulated weights of all frames. Time duration for each frame is then calculated by multiplying weight of that particular frame with a constant value t_{Base}=0.5 s such that W_{Total}*t_{Base})≤T_{Static}.

Users have control over output speed. The media processing model maintains t_{Base_min}=0.1 s and t_{Base_max}=2.5 s such that t_{Base} can be varied within this range for providing an option to the user to change overall output speed through a slider. t_{Base_min} is also used to make sure that a total output duration as calculated in above step (W_{Total}*t_{Base})≤T_{Static}) is within the maximum permissible time as per selected preset. Values of different variables, as mentioned alongside variable names, are chosen on the basis of user data as seen from software usage statistics. These values can be further personalized for users as they modify the auto assigned values for frame durations.

In some embodiments, the media processing model recommends the best presets as per total duration. Once the user has applied all the required contents on the frame and the user goes to the export screen, the media processing model recommends the best output duration using the methods and systems described above.

Systems and methods described in the present disclosure save time for users by eliminating the need to selectively go to each frame and set output duration. Users do not need to manually compute or set a duration for each of the frames in the media output file. If a user wants to generate multiple outputs with different durations for various sharing platforms, the described media processing model can generate desired media files in an instant. The media processing model computes and assigns different durations to each frame of the media output file based on their content type.

The present disclosure describes systems and methods that auto-assign duration to each frame used in creating an output media file based on output duration set by the user. The media processing apparatus sets a duration to the audio content applied on each frame used in creating the output media file based on output duration set by the user. The media processing apparatus sets a duration to the static graphic content applied on each frame based on output duration set by the user. The media processing apparatus sets a duration to the moving graphic content applied on each frame based on output duration set by the user. The media processing apparatus changes the overall speed of animated output with single user input.

The present disclosure describes systems and methods that improve on conventional media processing models by dynamically assigning durations to media content items based on their content type and a pre-determined final output duration (e.g., a target output length). The systems and methods described herein apply a weighting mechanism to account for content type and substance of a media content item to calculate a desired frame length. The media processing system enables tailored and proportional allocation of frame durations, such that the output media file aligns with platform requirements and user preferences. Additionally, the media processing system provides users with flexibility to control the duration of a specific media content item (e.g., the user can specify a duration) while automatically adjusting the durations of rest media content items. Therefore, media editing efficiency is improved.

The term “media content item” refers to a piece of digital content intended for displaying, viewing, editing, interaction, and consumption by users. The media content item exists in various formats, including but not limited to, text-based content (e.g., articles, blog posts, social media posts, news stories), audio content (e.g., music tracks, radio segments), visual content (e.g., images, infographics, digital art), video content (movies, video segments). In some examples, the content type for the media content item includes a static content type, an animated content type, a text content type, a graphic content type, or a combination thereof.

The term “duration” for the media content item refers to a length in time assigned to the media content item. In some cases, the duration is computed based on the content type of the media content item. The term “target duration” refers to a maximum length of duration imposed by a media platform (e.g., YouTube®, Instagram®) when uploading a media file for publication on the media platform. Different media sharing platforms may have different target durations.

### Media Processing

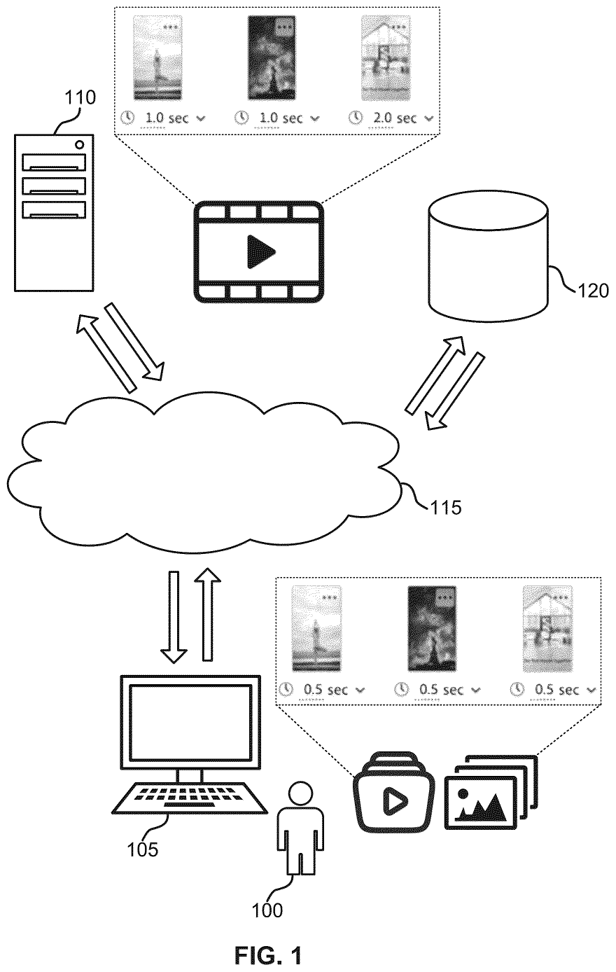

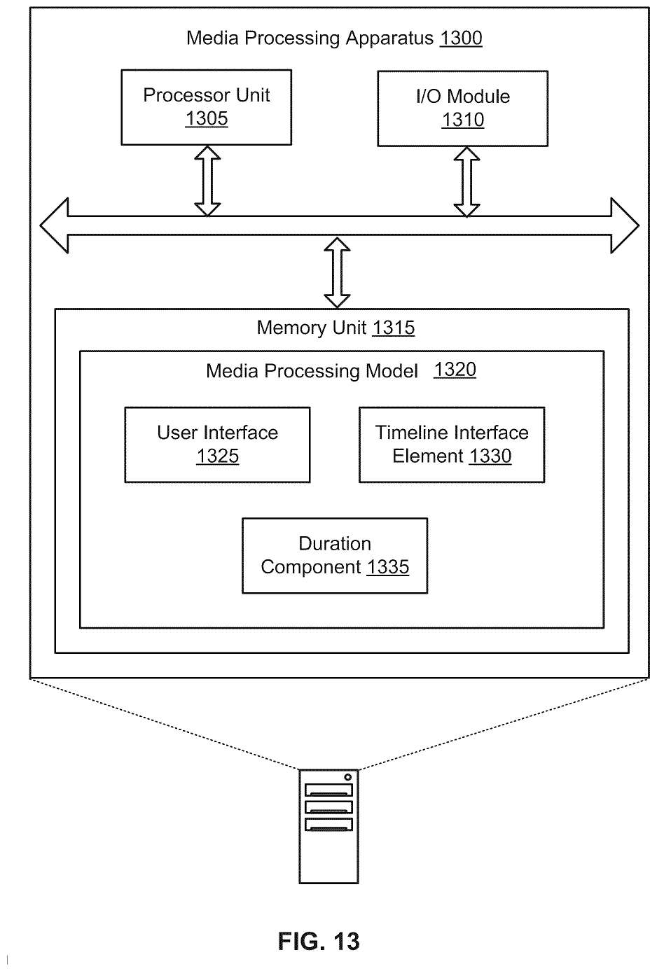

FIG. 1 shows an example of a media processing system according to aspects of the present disclosure. The example shown includes user 100, user device 105, media processing apparatus 110, cloud 115, and database 120. Media processing apparatus 110 is an example of, or includes aspects of, the corresponding element described with reference to FIG. 13.

In an example shown in FIG. 1, a set of media content items are provided by user 100. The set of media content items are to be included in an output media file generated by media processing apparatus 110. In some cases, the media content items include an animated (dynamic) image with graphic, an animated (dynamic) image with text, a static image, etc. In some examples, the output media file is of file format “.mp4”, “.pptx” or other proper media file format. In some cases, a default duration for each of the media content items is specified by user 100. In some examples, the default duration is set to 0.5 seconds for the media content items. The set of media content items are transmitted to media processing apparatus 110, e.g., via user device 105 and cloud 115.

Media processing apparatus 110 identifies a content type for each of the media content items. In some cases, the media content items have a content type of animated image with graphic, animated image with text, static image, etc. In some examples, the media content items have a “.mp4”, “.gif” “.png”, “.jpeg” format, etc. In some examples, three media content items in the example are images. Media processing apparatus 110 computes a duration for each of the one or more media content items based on the identified content type. In some examples, media processing apparatus 110 computes and assigns a duration of 1.0 second to a first image and a second image, and a duration of 2.0 seconds to a third image. Media processing apparatus 110 returns a generated media file including the set of media content items to user 100 via cloud 115 and user device 105. The one or more of the set of media content items are assigned the computed duration in the output media file. In some examples, the output media file is a video including the three images. The first image and second image both last 1.0 second in the video while the third image lasts 2.0 seconds in the video, i.e., computed duration based on their content types.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the media processing application on user device 105 may include functions of media processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

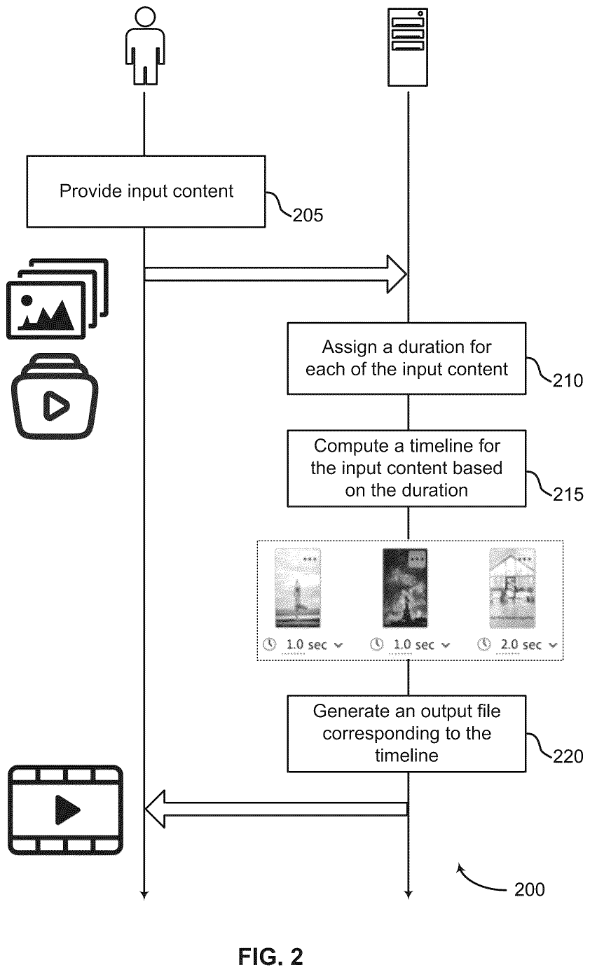

Media processing apparatus 110 includes a computer-implemented network comprising a user interface, timeline interface element, and duration component. Media processing apparatus 110 may also include a processor unit, a memory unit, and an I/O module. Additionally, media processing apparatus 110 can communicate with database 120 via cloud 115. Further detail regarding the architecture of media processing apparatus 110 is provided with reference to FIG. 13. Further detail regarding the operation of media processing apparatus 110 is provided with reference to FIGS. 2, 12, and 14-16.

In some cases, media processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of a method 200 for media generation according to aspects of the present disclosure. In some examples, method 200 describes an operation of the media processing model 1320 described with reference to FIG. 13. In some examples, these operations are performed by a system including a processor executing a set of codes to control functional elements of an apparatus such as the media processing apparatus described in FIGS. 1 and 13.

Additionally or alternatively, steps of the method 200 may be performed using special-purpose hardware. Generally, these operations are performed according to the methods and processes described in accordance with aspects of the present disclosure. In some cases, the operations described herein are composed of various substeps or are performed in conjunction with other operations.

At operation 205, the user provides input content. In some cases, the operations of this step refer to, or may be performed by, a user as described with reference to FIG. 1. In some cases, input content includes a set of media content items. The set of media content items are of file formats such as “.mp4”, “.gif,” “.png” or “jpeg”, or any combination thereof. In some cases, the media content items constitute a set of frames for an output media file. In some cases, each of the media content items is referred to as a frame of the output media file. The media content items contain animated text, static text, animated graphics, static graphics, or any combination thereof.

At operation 210, the system assigns a duration for each of the input content. In some cases, the operations of this step refer to, or may be performed by, a media processing apparatus as described with reference to FIG. 1 or 13. In some cases, base duration corresponding to animated text and animated graphics is predetermined, e.g., a predefined duration of 3 s, 6 s or 9 s.

In some examples, users may choose a preset for final output like YouTube® shorts, Instagram® reels, etc. Based on the selected preset, the system obtains a maximum output duration (T_{Max}), such as 90 sec for Instagram® reels.

At operation 215, the system computes a timeline for the input content based on the duration. In some cases, the operations of this step refer to, or may be performed by, a media processing apparatus as described with reference to FIG. 1. In some cases, a “timeline” refers to an arrangement or combination of durations corresponding to each of the set of media content items to appear in a media file, for example durations corresponding to each frame in a video.

At operation 220, the system generates an output media file corresponding to the timeline. In some cases, the operations of this step refer to, or may be performed by, a media processing apparatus as described with reference to FIG. 1 or 13. In some examples, the generated output file is a video file including animated (dynamic) images with graphics, animated (dynamic) images with text, static images, or any combination thereof. In some cases, the output file is uploaded and/or published at a media sharing platform such as YouTube® or Instagram®.

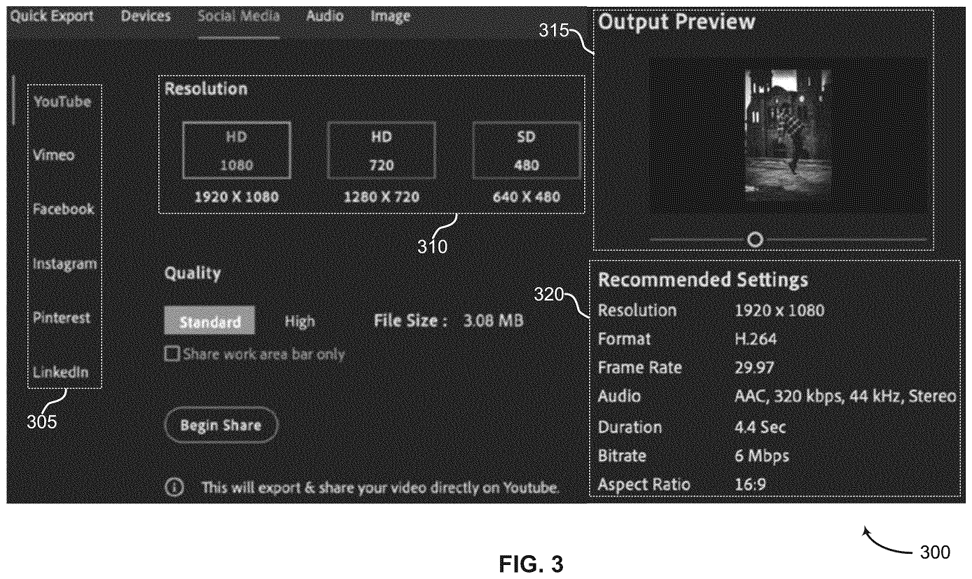

FIG. 3 shows an example of a user interface 300 for the media processing system according to aspects of the present disclosure. The example shown includes user interface 300, media platform 305, candidate resolutions 310, output preview 315, and settings 320.

In an example shown in FIG. 3, user interface 300 displays output preset options available to user 100 when exporting a media output file. In some cases, a final output is a video document for publishing on a media platform 305. Examples of media platform 305 include YouTube®, Instagram®, Vimeo®, Facebook®, Pinterest®, LinkedIn®, etc. If user 100 selects YouTube® as media platform 305, user interface 300 displays a message “This will export & share your video directly on YouTube”.

Users select from candidate resolutions 310 which includes one or more preset resolutions for the media output. In some examples, candidate resolutions 310 include High Definition (“HD”) and Standard Definition (“SD”). Candidate resolutions 310 include High Definition with resolution of 1920×1080 pixels (“HD 1080”), High Definition with resolution of 1280×720 pixels (“HD 720”), Standard Definition with resolution of 480 pixels (“SD 480”), etc.

Output preview 315 displays a preview of an output file, e.g., a frame of the output file is shown in output preview 315. The media output file includes a set of frames comprising images having animated graphics, static images, image having animated text, or any combination thereof. For example, a frame of the output file, via output preview 315, shows an image of a person jumping on the ground in front of a building.

Settings 320 (or recommended settings) include one or more preset settings or parameters of the media file for user selection. Settings 320 include resolution, format, frame rate, audio parameters, duration, bitrate, aspect ratio, etc. In this example, settings 320 include resolution of 1920×1080, format of “H.264”, frame rate of 29.97, audio parameters of “AAC, 320 kbps, 44kHZ, Stereo”, duration of 4.4 Seconds, bitrate of 6 Mbps, aspect ratio of 16:9.

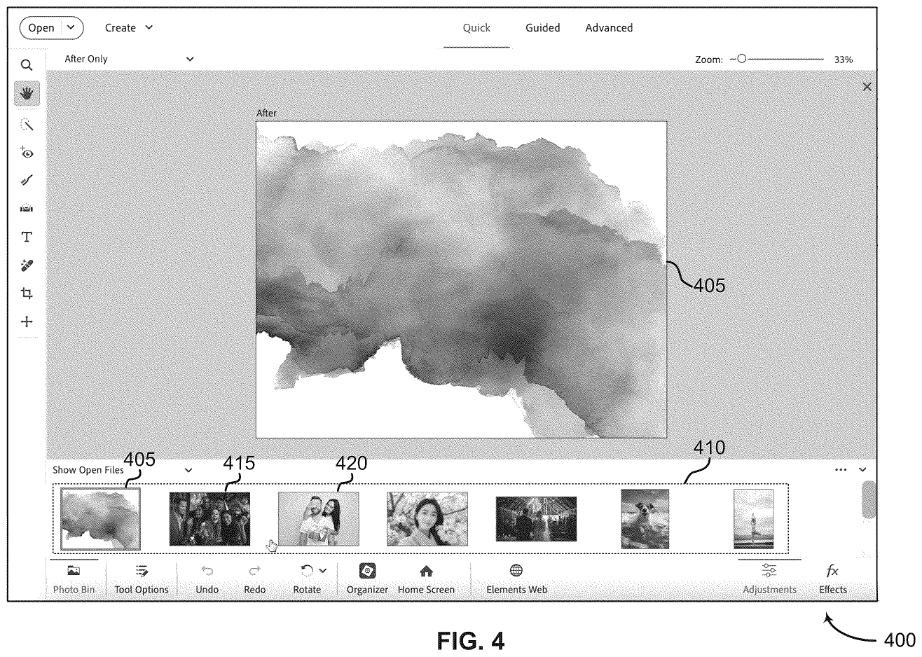

FIG. 4 shows an example of a user interface 400 including a set of media content items according to aspects of the present disclosure. The example shown includes user interface 400, first media content item 405, a set of media content items 410, second media content item 415, and third media content item 420. User interface 400 is an example of, or includes aspects of, the corresponding element described with reference to FIGS. 3, 5, 7-11, and 13.

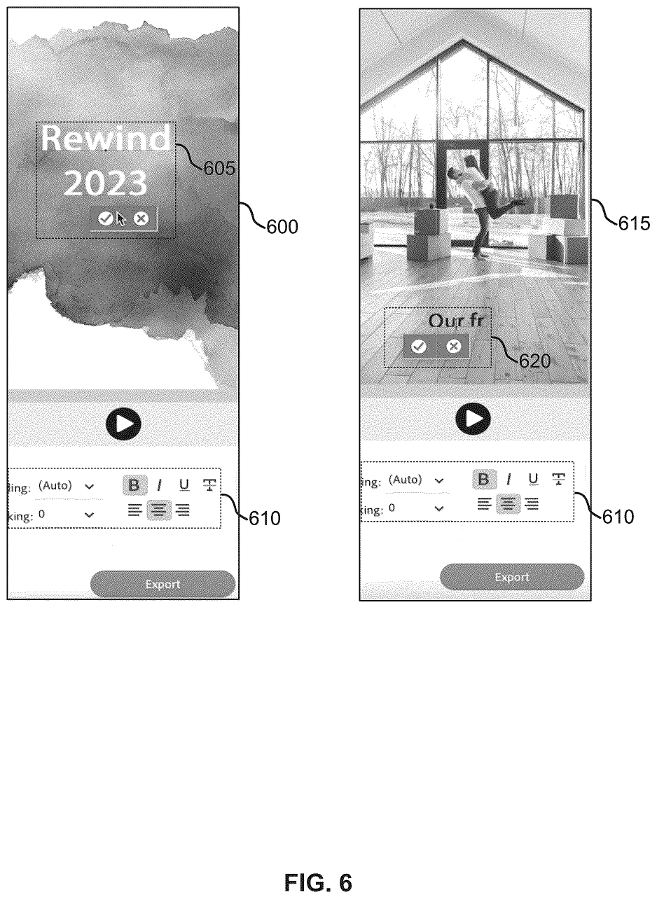

In an example shown in FIG. 4, a set of media content items 410 includes one or more media content items, such as first media content item 405, second media content item 415, third media content item 420, or any combination thereof. The first media content item 405 is an image depicting a cloud theme background. The first media content item 405 is displayed as a full-scale image in the center of user interface 400. The first media content item 405 is also displayed as a thumbnail image at the bottom of user interface 400. The first media content item 405 is an example of, or includes aspects of, the corresponding element described with reference to FIG. 6.

The second media content item 415 depicts a crowd of people and is arranged after the first media content item 405. The third media content item 420 depicts a couple and is arranged after the second media content item 415. The set of media content items 410 are images. The set of media content items 410 are arranged in a sequential manner, e.g., one frame after another frame. The first media content item 405 is an example of, or includes aspects of, the corresponding element described with reference to FIG. 6.

In some examples, content types for the set of media content items 410 include a static content type, an animated content type, a text content type, a graphic content type, an audio content type, or a combination thereof.

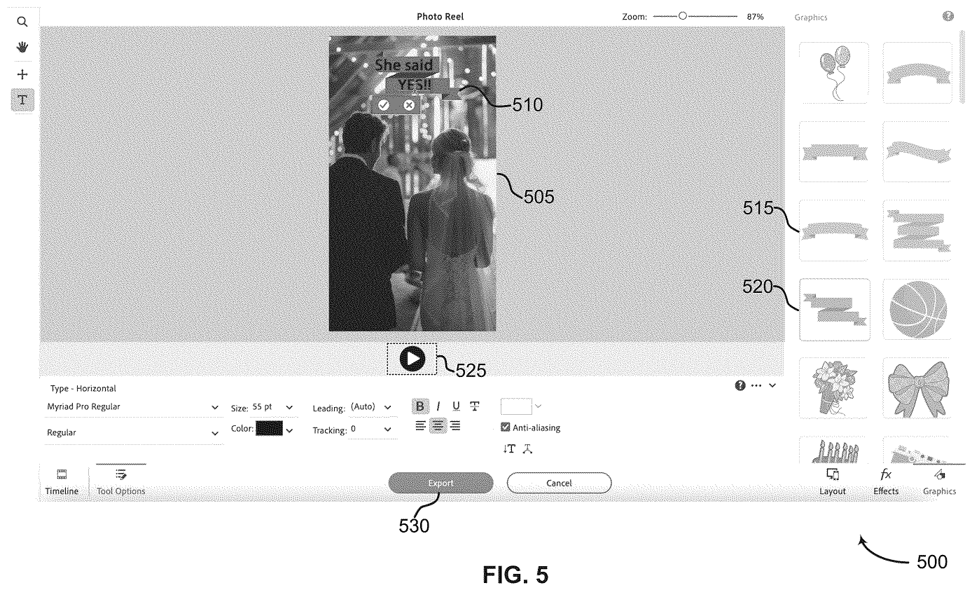

FIG. 5 shows an example of a user interface 500 for editing a media content item 505 according to aspects of the present disclosure. The example shown includes user interface 500, media content item 505, animated content element 510, first candidate style 515, second candidate style 520, media play element 525, and export element 530. User interface 500 is an example of, or includes aspects of, the corresponding element described with reference to FIGS. 3, 4, 7-11, and 13.

According to some embodiments, user interface 500 obtains a style preset. In some examples, user interface 500 applies the style preset to media content item 505. A user watches animated effect associated with media content item 505 by clicking on media play element 525. The user exports media content to an output file by clicking on export element 530, where the output file includes media content item 505 comprising the style preset. The style preset includes first candidate style 515, second candidate style 520, or other preset styles listed in the right-hand panel of user interface 500. The media content item 505 is an image depicting a couple at a wedding ceremony. Media content item 505 is an example of, or includes aspects of, the corresponding element described with reference to FIGS. 4, 7-9, and 11.

The media content item 505 includes animated content element 510. The animated content element 510 is a text element having an animated effect (i.e., animated text). The text element is “She said YES!!”. The animated content element 510 is associated with animated effect, e.g., text, a ribbon, text on a ribbon, etc. The animated content element 510 displays the text portion on a ribbon. In some cases, user interface 500 displays two options (a check icon, remove icon) associated with the animated content element 510.

First candidate style 515 and second candidate style 520 are examples in a set of style presets located on the right-hand style panel of user interface 500. The first candidate style 515 is different from the second candidate style 520. The first candidate style 515 is a ribbon of a first pattern and the second candidate style 520 is a ribbon of a second pattern different from the first pattern.

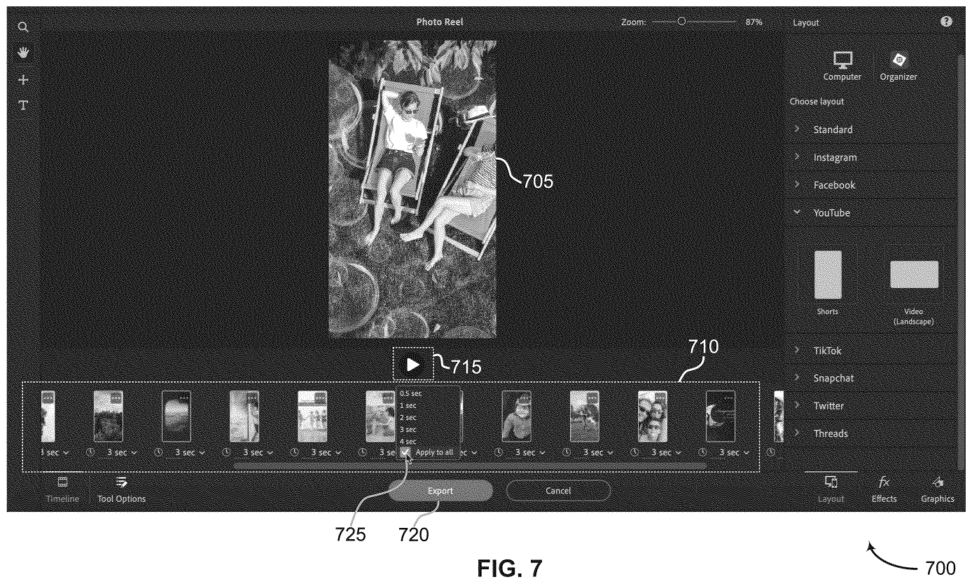

Media play element 525 is an example of, or includes aspects of, the corresponding element described with reference to FIGS. 7-9, and 11.

Export element 530 is an example of, or includes aspects of, the corresponding element described with reference to FIGS. 7-9, and 11. In some examples, output options are available to users when clicking on export element 530 and details about export are described above with reference to FIG. 3.

FIG. 6 shows an example of a user interface including animated elements with text elements according to aspects of the present disclosure. The example shown includes first media content item 600, first animated content element 605, editing panel 610, second media content item 615, and second animated content element 620.

According to some embodiments, editing panel 610 is used to edit the first media content item 600. The first media content item 600 includes the first animated content element 605. The editing panel 610 is used to edit the second media content item 615. The second media content item 615 includes the second animated content element 620. The first media content item 600 is an image depicting a cloud theme background. The first animated content element 605 includes text “Rewind 2023” having animation effect. The second media content item 615 is an image depicting a couple inside a house. The second animated content element 620 includes unfinished text “Our fr” having certain animation effect. In some examples, editing panel 610 includes options such as bold, italic, underline, cross off, align to the left, align in the middle, align to the right, etc.

First media content item 600 and/or second media content item 615 is an example of, or includes aspects of, the corresponding element described with reference to FIGS. 4-5. First animated content element 605 and/or second media content item 615 is an example of, or includes aspects of, the corresponding element described with reference to FIGS. 4-5.

FIG. 7 shows an example of a user interface 700 including duration propagation according to aspects of the present disclosure. The example shown includes user interface 700, media content item 705, timeline interface element 710, media play element 715, export element 720, and duration parameter 725. User interface 700 is an example of, or includes aspects of, the corresponding element described with reference to FIGS. 3-5, 8-11, and 13.

According to some embodiments, user interface 700 displays media content item 705, timeline interface element 710, media play element 715, export element 720, and duration parameter 725. A user watches a set of media content items (shown in timeline interface element 710) by clicking on media play element 715. The user exports the media content items to a media output file by clicking on export element 720. In some cases, the user sets a duration for one of the media content items. Additionally or alternatively, the user applies the same duration to all of the media content items by checking the box of duration parameter 725.

According to some embodiments, user interface 700 receives a user input indicating the target duration. In some examples, user interface 700 obtains a user input indicating a base duration for the set of media content items, where the duration is computed based on the base duration. In some examples, user interface 700 receives a user input indicating a target aspect ratio, where the media file includes the target aspect ratio. User interface 700 is an example of, or includes aspects of, the corresponding element described with reference to FIGS. 4, 5, 8-11, and 13.

In an example as shown in FIG. 7, media content item 705 is an image depicting two people lying on their couches. Media content item 705 is an example of, or includes aspects of, the corresponding element described with reference to FIGS. 5, 8, 9, and 11.

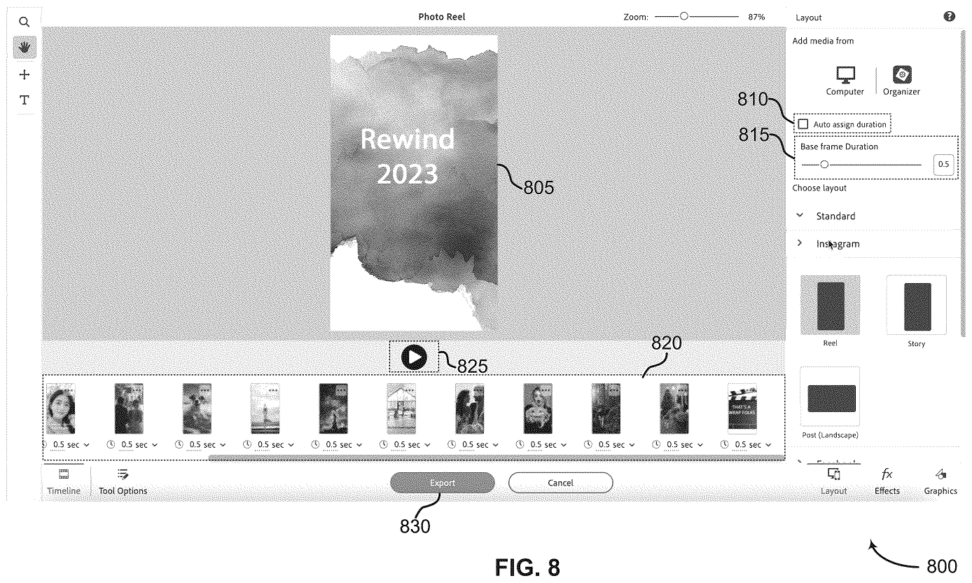

According to some embodiments, timeline interface element 710 displays the set of media content items (including media content item 705) in sequence, where each of the media content items has a default duration (e.g., 3 seconds). In some examples, timeline interface element 710 receives a duration input indicating an additional duration for an additional media content item via the timeline interface element 710, where the media file includes the additional media content item with the additional duration. In some cases, the duration for the media content items is the same (e.g., 3 seconds). Timeline interface element 710 is an example of, or includes aspects of, the corresponding element described with reference to FIGS. 8, 9, 11, and 13.

The user watches the media content items as a sequence of frames by clicking on media play element 715. The sequence of frames are arranged in an ordering shown in timeline interface element 710. Media play element 715 is an example of, or includes aspects of, the corresponding element described with reference to FIGS. 5, 8, 9, and 11.

The user exports the set of media content items to a media output file by clicking on export element 720. Export element 720 is an example of, or includes aspects of, the corresponding element described with reference to FIGS. 5, 8, 9, and 11.

In some examples, users select a duration and apply the duration to one or more media content items by modifying the duration parameter 725. Duration parameter 725 includes options of 0.5 second, 1 second, 2 seconds, 3 seconds, 4 seconds, or other options. Duration parameter 725 includes an option to apply a selected duration to all media content items shown in timeline interface element 710, e.g., “Apply to all” check box. In some cases, the preset durations reflect preferable preset durations as per total duration. Duration parameter 725 is an example of, or includes aspects of, the corresponding element described with reference to FIGS. 8, 9, and 11.

FIG. 8 shows an example of a user interface 800 including auto-assign duration before auto-assign according to aspects of the present disclosure. The example shown includes user interface 800, media content item 805, duration parameter 810, base duration slider 815, timeline interface element 820, media play element 825, and export element 830. User interface 800 is an example of, or includes aspects of, the corresponding element described with reference to FIGS. 3-5, 7, 9-11, and 13.

According to some embodiments, user interface 800 receives a user input indicating the target duration. In some examples, user interface 800 obtains a user input indicating a base duration for the set of media content items, where the duration is computed based on the base duration. In some examples, user interface 800 receives a user input indicating a target aspect ratio, where the media file includes the target aspect ratio. According to some aspects, user interface 800 receives a user input indicating a target aspect ratio, where the media file includes the target aspect ratio. According to some aspects, user interface 800 is configured to obtain a user input indicating a base duration for the set of media content items, wherein the duration is computed based on the base duration.

According to some embodiments, user interface 800 displays a base duration adjustment tool via base duration slider 815, and an option to apply auto-assign duration via checking the duration parameter 810. User interface 800 displays media content item 805, timeline interface element 820, media play element 825, and export element 830. In some examples, animated graphics content itself has a predefined duration such as 3 s, 6 s and 9 s for gifs or mp4 content.

In some examples, a user selects auto-assign duration via checking the duration parameter 810. Media processing model 1320 described with reference to FIG. 13 computes a duration for each of the media content items based on a base frame duration (e.g., base frame duration is set to 0.5 second in FIG. 8).

In an example as shown in FIG. 8, media content item 805 is an image depicting a cloud background having text effect “Rewind 2023”. Media content item 805 is an example of, or includes aspects of, the corresponding element described with reference to FIGS. 5, 7, 9, and 11.

User interface 800 displays an option to apply auto-assign duration via selecting duration parameter 810. The auto assign duration box is not checked yet. Duration parameter 810 is an example of, or includes aspects of, the corresponding element described with reference to FIGS. 7, 9, and 11.

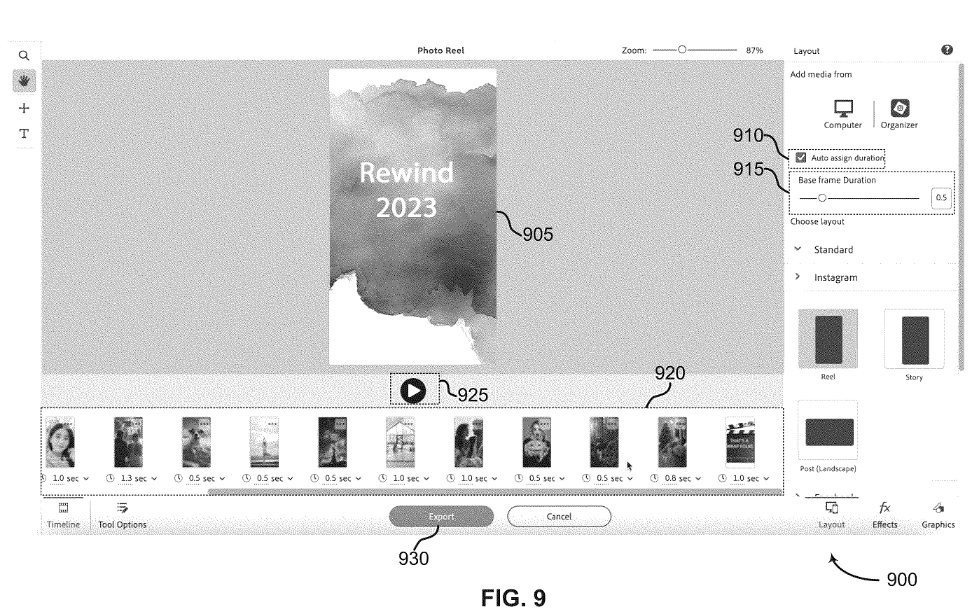

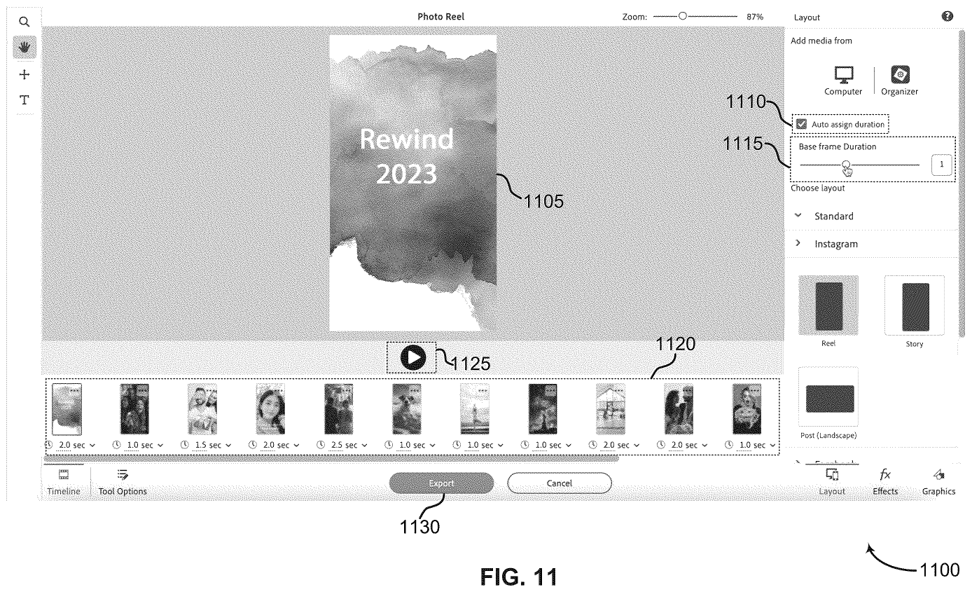

User interface 800 displays a base duration adjustment tool via base duration slider 815. The base duration slider 815 is set to a base duration of 0.5 seconds. If apply auto-assign duration is not enabled via duration parameter 810, each of the media content items (timeline interface element 820) is set to have a base duration of 0.5 seconds. In some cases, by sliding left or right using base duration slider 815, a base duration is adjusted. Base duration slider 815 is an example of, or includes aspects of, the corresponding element described with reference to FIGS. 9 and 11.

The timeline interface element 820 includes and displays the set of media content items in sequence. Each of the media content items is assigned a duration of 0.5 seconds. Timeline interface element 820 is an example of, or includes aspects of, the corresponding element described with reference to FIGS. 7, 9, 11, and 13.

Users may watch the media content items in sequence by clicking on the media play element 825. Media play element 825 is an example of, or includes aspects of, the corresponding element described with reference to FIGS. 5, 7, 9, and 11.

Users export the media content items to a media output file by clicking on export element 830. Export element 830 is an example of, or includes aspects of, the corresponding element described with reference to FIGS. 5, 7, 9, and 11.

FIG. 9 shows an example of a user interface 900 including auto-assign duration after auto-assign according to aspects of the present disclosure. The example shown includes user interface 900, media content item 905, duration parameter 910, base duration slider 915, timeline interface element 920, media play element 925, and export element 930. User interface 900 is an example of, or includes aspects of, the corresponding element described with reference to FIGS. 3-5, 7, 8, 10, 11, and 13.

According to an embodiment, user interface 900 displays media content item 905, duration parameter 910, base duration slider 915, timeline interface element 920, media play element 925, and export element 930. In an example shown in FIG. 9, media content item 905 is an image depicting a cloud background having text element “Rewind 2023”. Media content item 905 is an example of, or includes aspects of, the corresponding element described with reference to FIGS. 5, 7, 8, and 11.

User interface 900 displays an option to apply auto-assign by checking the duration parameter 910. The “auto assign duration” box is checked, i.e., duration parameter 910 is selected. Duration parameter 910 is an example of, or includes aspects of, the corresponding element described with reference to FIGS. 7, 8, and 11.

User interface 900 displays a base duration adjustment tool, i.e., base duration slider 915. Base duration slider 915 is set to 0.5 seconds. One or more media content items have a duration other than 0.5 seconds because duration parameter 910 is selected.

One of the media content items shown in timeline interface element 920 is assigned a duration of 1 second using media processing model 1320 (described with reference to FIG. 13). Another media content item shown in timeline interface element 920 is assigned a duration of 1.3 seconds using media processing model 1320. Base duration slider 915 is an example of, or includes aspects of, the corresponding element described with reference to FIGS. 8 and 11.

In some examples, one or more media content items shown in timeline interface element 920 are assigned a duration different from the base duration set by base duration slider 915 (e.g., 0.5 seconds). The frames listed in timeline interface element 920 are assigned a duration of 1.3 seconds, 1 second, 0.8 seconds, etc. Timeline interface element 920 is an example of, or includes aspects of, the corresponding element described with reference to FIGS. 7, 8, 11, and 13.

Media play element 925 is an example of, or includes aspects of, the corresponding element described with reference to FIGS. 5, 7, 8, and 11. Export element 930 is an example of, or includes aspects of, the corresponding element described with reference to FIGS. 5, 7, 8, and 11.

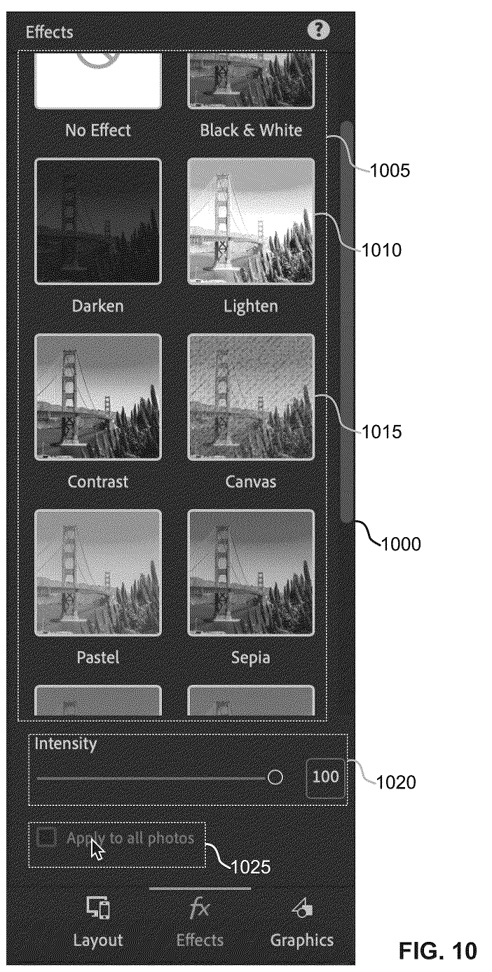

FIG. 10 shows an example of a user interface 1000 including filter effects according to aspects of the present disclosure. The example shown includes user interface 1000, a set of filter effects 1005, intensity slider 1020, and image parameter 1025. User interface 1000 is an example of, or includes aspects of, the corresponding element described with reference to FIGS. 3-5, 7-9, 11, and 13.

In some examples, user interface 1000 displays a set of filter effects 1005, intensity slider 1020, and image parameter 1025. The set of filter effects 1005 includes first filter effect 1010 and second filter effect 1015. The first filter effect 1010 is different from second filter effect 1015. The set of filter effects 1005 includes other filter effects that are different from the first filter effect 1010 and the second filter effect 1015.

In an example as shown in FIG. 10, the first filter effect 1010 is a “Lighten” effect used to adjust the color or brightness of a media content item. The second filter effect 1015 is a “Canvas” effect is used to provide or apply a canvas painting effect for a media content item.

In some examples, intensity slider 1020 is used to select and modify an intensity value for a media content item. The intensity value, via intensity slider 1020, is a scalar from 0 to 100 indicating a degree of intensity associated with a target filter effect to be applied to a media content item. In the above example, intensity slider 1020 is moved to the rightmost end and accordingly intensity is at 100 (highest intensity).

Image parameter 1025 is used to apply a target filter effect and/or intensity to all media content items (e.g., apply to all photos). In some examples, by checking image parameter 1025, media processing model 1320 consistently applies the first filter effect 1010 (a “Lighten” effect) to a set of media content items, where the intensity value is set to 100.

FIG. 11 shows an example of a user interface 1100 including auto-assigning duration according to aspects of the present disclosure. The example shown includes user interface 1100, media content item 1105, duration parameter 1110, base duration slider 1115, timeline interface element 1120, media play element 1125, and export element 1130. User interface 1100 is an example of, or includes aspects of, the corresponding element described with reference to FIGS. 3-5, 7-10, and 13.

According to an embodiment, user interface 1100 displays media content item 1105, duration parameter 1110, base duration slider 1115, timeline interface element 1120, media play element 1125, and export element 1130. In an example as shown in FIG. 11, media content item 1105 is an image depicting a cloud background having text element “Rewind 2023”. Media content item 1105 is an example of, or includes aspects of, the corresponding element described with reference to FIG. 5, and 7-9.

User interface 1100 displays an option to apply auto-assign duration by selecting the duration parameter 1110. The “auto assign duration” box is checked (i.e., duration parameter 1110 is selected). Duration parameter 1110 is an example of, or includes aspects of, the corresponding element described with reference to FIGS. 7-9.

User interface 1100 displays a base duration adjustment tool via adjusting base duration slider 1115. A user changes the base duration from 0.5 seconds to 1 second via the base duration slider 1115. After the base duration adjustment, base duration slider 1115 displays a value of 1 (i.e., 1 second). One or more media content items have a duration of 0.5 second will be adjusted to 1 second because duration parameter 1110 is selected (i.e., box is checked) and the length of duration for the one or more media content items are automatically assigned.

In some cases, by adjusting the base duration via base duration slider 1115, an overall speed of a media output file may be changed. Base duration slider 1115 is an example of, or includes aspects of, the corresponding element described with reference to FIGS. 8 and 9.

In some examples, one or more media content items shown in timeline interface element 1120 are assigned a duration different from the base duration set by base duration slider 1115 (e.g., 1 second). The frames listed in timeline interface element 1120 are assigned a duration of 2 seconds, 1.5 seconds, 2.5 seconds, etc. Timeline interface element 1120 is an example of, or includes aspects of, the corresponding element described with reference to FIGS. 7-9, and 13.

Media play element 1125 is an example of, or includes aspects of, the corresponding element described with reference to FIG. 5, and 7-9. Export element 1130 is an example of, or includes aspects of, the corresponding element described with reference to FIG. 5, and 7-9.

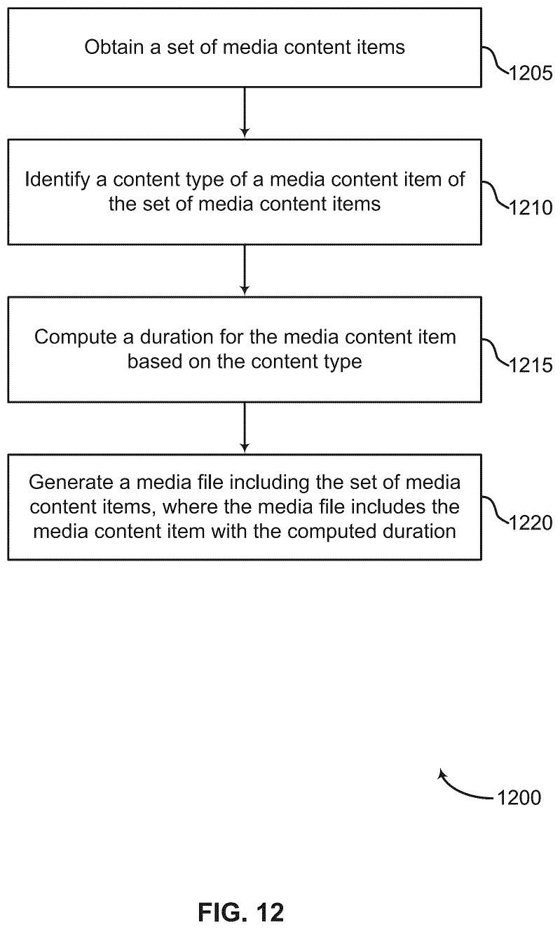

FIG. 12 shows an example of a method 1200 for media processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1205, the system obtains a set of media content items. In some cases, the operations of this step refer to, or may be performed by, a media processing model as described with reference to FIG. 13.

At operation 1210, the system identifies a content type of a media content item of the set of media content items. In some cases, the operations of this step refer to, or may be performed by, a media processing model as described with reference to FIG. 13. In some examples, content types for the set of media content items include a static content type, an animated content type, a text content type, a graphic content type, an audio content type, or a combination thereof.

In some cases, the media content items may include animated text, animated graphics, static images, etc. The media content item corresponds a frame in the media output file. The system obtains a maximum output duration (T_{Max}), such as 90 seconds for Instagram® reels. For these types of frames, user selected content is not modified by trimming/duplicating or by changing the frame rate of animated content. Instead, a frame duration is automatically determined by the duration of the preset as described below. Let T_{Animated} be the total time of all animated contents (e.g., text, graphics) applied on the frames. If the maximum output duration (T_{Max}) is less than T_{Animated}, the media processing model trims the animation to the maximum duration possible (T_{Max}) and warns the user about not being able to fit the final output within the stipulated threshold.

At operation 1215, the system computes a duration for the media content item based on the content type. In some cases, the operations of this step refer to, or may be performed by, a media processing model as described with reference to FIG. 13.

In some cases, the media content items include static content, such as static images. If the maximum output duration (T_{Max}) is more than or no less than T_{Animated}, part of remaining time (T_{Static}=T_{Max}−T_{Animated}) is then assigned to static content (e.g., images, graphics, text) as described below.

Each of the frames (input image) is assigned an initial weight of 1.0. Each of the other input types (graphics, text) are then assigned heuristically determined weights. In some cases, w_{Graphic}=0.5 and w_{Text}=1 denote weights for graphics and text, respectively. Weight for each of the frames is then calculated on the basis of what all a frame contains. e.g., a frame having 2 graphics and 1 text layer on top of image has an additional weight of (2*w_{Graphic})+w_{Text}. A frame with one image is assigned the minimum weight=1.0.

In some cases, W_{Total} denotes the accumulated weights of all frames. Time duration for each frame is then calculated by multiplying weight of that particular frame with a constant value t_{Base}=0.5 s such that (W_{Total}*t_{Base})≤T_{Static}.

In some cases, the media content items correspond to frames of animated or static contents, such as animated or static graphics and/or texts. User control for output speed is implemented. In some cases, it is also maintained that t_{Base_min}=0.1 s and t_{Base_max}=2.5 s such that the following is satisfied: t_{Base} may vary within the range recited above for the user to change overall output speed through a slider. t_{Base_min} is also used to make sure that total output duration as calculated above is within the maximum permissible time as per selected preset.

Values of different variables, as mentioned in parentheses alongside variable names above, have been chosen on the basis of user data as seen from user statistics. In some cases, the intended final output file is photo reel, and user statistics refer to photo reel feature usage statistics. In some cases, the values for the different variables are further personalized for users as they modify the auto assigned values for frame durations.

At operation 1220, the system generates a media file including the set of media content items, where the media file includes the media content item with the computed duration. In some cases, the operations of this step refer to, or may be performed by, a media processing model as described with reference to FIG. 13.

In FIGS. 1-12, a method, apparatus, non-transitory computer readable medium, and system for media processing are described. One or more aspects of the method, apparatus, non-transitory computer readable medium, and system include obtaining a set of media content items; identifying a content type of a media content item of the set of media content items; computing a duration for the media content item based on the content type; and generating a media file including the set of media content items, wherein the media file comprises the media content item with the computed duration.

Some examples of the method, apparatus, non-transitory computer readable medium, and system further include identifying a target duration for the media file, wherein the media file is generated based on the target duration.

Some examples of the method, apparatus, non-transitory computer readable medium, and system further include receiving a user input indicating the target duration.

Some examples of the method, apparatus, non-transitory computer readable medium, and system further include computing a weight for the media content item based on the content type. Some examples further include dividing the target duration among the set of media content items based on the weight.

Some examples of the method, apparatus, non-transitory computer readable medium, and system further include obtaining a user profile, wherein the duration of the media content item is computed based on the user profile.

Some examples of the method, apparatus, non-transitory computer readable medium, and system further include obtaining a user input indicating a base duration for the set of media content items, wherein the duration is computed based on the base duration.

Some examples of the method, apparatus, non-transitory computer readable medium, and system further include displaying the set of media content items in a timeline interface element.

Some examples of the method, apparatus, non-transitory computer readable medium, and system further include receiving a duration input indicating an additional duration for an additional media content item via the timeline interface element, wherein the media file comprises the additional media content item with the additional duration.

Some examples of the method, apparatus, non-transitory computer readable medium, and system further include computing an additional duration for an additional media content item based on the duration for the media content item, wherein the media file comprises the additional media content item with the additional duration.

In some aspects, the content type of the media content item comprises an animated content type, and wherein the additional duration is computed after the duration based on the animated content type.

Some examples of the method, apparatus, non-transitory computer readable medium, and system further include determining the content type from a set of content types including a static content type, an animated content type, a text content type, a graphic content type, an audio content type, or a combination thereof.

Some examples of the method, apparatus, non-transitory computer readable medium, and system further include receiving a user input indicating a target aspect ratio, wherein the media file comprises the target aspect ratio.

Some examples of the method, apparatus, non-transitory computer readable medium, and system further include obtaining a style preset. Some examples further include applying the style preset to the media content item, wherein the media file comprises the media content item with the style preset.

### Model Architecture

FIG. 13 shows an example of a media processing apparatus 1300 according to aspects of the present disclosure. The example shown includes processor unit 1305, I/O module 1310, memory unit 1315, and media processing model 1320. Media processing apparatus 1300 is an example of, or includes aspects of, the corresponding element described with reference to FIG. 1.

Processor unit 1305 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

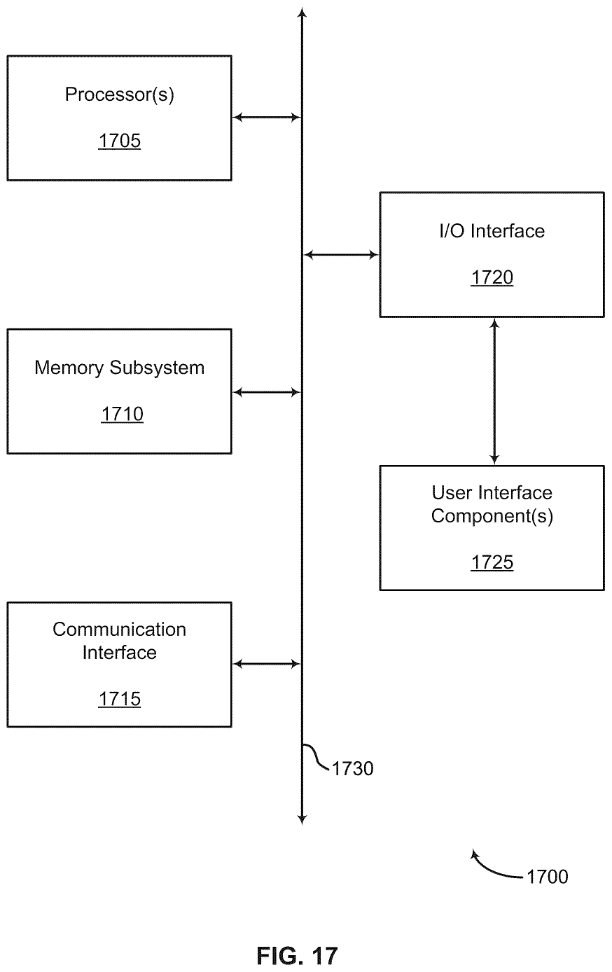

In some cases, processor unit 1305 is configured to operate a memory array using a memory controller. In other cases, a memory controller is integrated into processor unit 1305. In some cases, processor unit 1305 is configured to execute computer-readable instructions stored in memory unit 1315 to perform various functions. In some aspects, processor unit 1305 includes special-purpose components for modem processing, baseband processing, digital signal processing, or transmission processing. According to some aspects, processor unit 1305 comprises one or more processors described with reference to FIG. 17.

Memory unit 1315 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1305 to perform various functions described herein.

In some cases, memory unit 1315 includes a basic input/output system (BIOS) that controls basic hardware or software operations, such as an interaction with peripheral components or devices. In some cases, memory unit 1315 includes a memory controller that operates memory cells of memory unit 1315. For example, the memory controller may include a row decoder, column decoder, or both. In some cases, memory cells within memory unit 1315 store information in the form of a logical state. According to some aspects, memory unit 1315 is an example of the memory subsystem 1710 described with reference to FIG. 17.

According to some aspects, media processing apparatus 1300 uses one or more processors of processor unit 1305 to execute instructions stored in memory unit 1315 to perform functions described herein. For example, media processing apparatus 1300 obtains a set of media content items. Media processing apparatus 1300 identifies a content type of a media content item of the set of media content items. Media processing apparatus 1300 computes a duration for the media content item based on the content type. Media processing apparatus 1300 generates a media file including the set of media content items, where the media file comprises the media content item with the computed duration.

I/O module 1310 receives inputs from and transmits outputs of the media processing apparatus 1300 to other devices or users. For example, I/O module 1310 receives inputs for the media processing model 1320 and transmits outputs of the media processing model 1320. According to some aspects, I/O module 1310 is an example of the I/O interface 1720 described with reference to FIG. 17.

In some embodiments, media processing model 1320 includes an artificial neural network (ANN) that obtains a user profile and computes a duration of a media content item based on the user profile using machine learning algorithms. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the ANN can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

According to some embodiments, media processing model 1320 obtains a set of media content items. In some examples, media processing model 1320 identifies a content type of a media content item of the set of media content items. Media processing model 1320 computes a duration for the media content item based on the content type. Media processing model 1320 generates a media file including the set of media content items, where the media file comprises the media content item with the computed duration.

In an embodiment, media processing model 1320 includes user interface 1325, timeline interface element 1330, and duration component 1335. User interface 1325 is an example of, or includes aspects of, the corresponding element described with reference to FIGS. 3-5, and 7-11. According to some aspects, user interface 1325 obtains a user input indicating a base duration for the set of media content items, wherein the duration is computed based on the base duration.

Timeline interface element 1330 is an example of, or includes aspects of, the corresponding element described with reference to FIGS. 7-9, and 11. In some examples, timeline interface element 1330 displays the set of media content items.

According to some embodiments, duration component 1335 identifies a target duration for the media file, where the media file is generated based on the target duration. In some examples, duration component 1335 computes a weight for the media content item based on the content type. In some examples, duration component 1335 divides the target duration among the set of media content items based on the weight. In some examples, duration component 1335 computes the duration based on the based duration obtained by user interface 1325.

According to some embodiments, duration component 1335 determines a first duration of the animated content item. In some examples, duration component 1335 computes a second duration of the static content item based on the first duration. In some examples, duration component 1335 identifies a target duration for the media file, where the media file is generated based on the target duration.

In FIG. 13, an apparatus, system, and method for media processing are described. One or more embodiments of the apparatus, system, and method include a memory component; a processing device coupled to the memory component, the processing device configured to perform operations comprising; obtaining a set of media content items; identifying a content type of a media content item of the set of media content items; computing a duration for the media content item based on the content type; and generating a media file including the set of media content items, wherein the media file comprises the media content item with the computed duration.

Some examples of the apparatus, system, and method further include a user interface configured to obtain a user input indicating a base duration for the set of media content items, wherein the duration is computed based on the base duration. Some examples of the apparatus, system, and method further include a timeline interface element configured to display the set of media content items.

### Intelligent Duration Computation

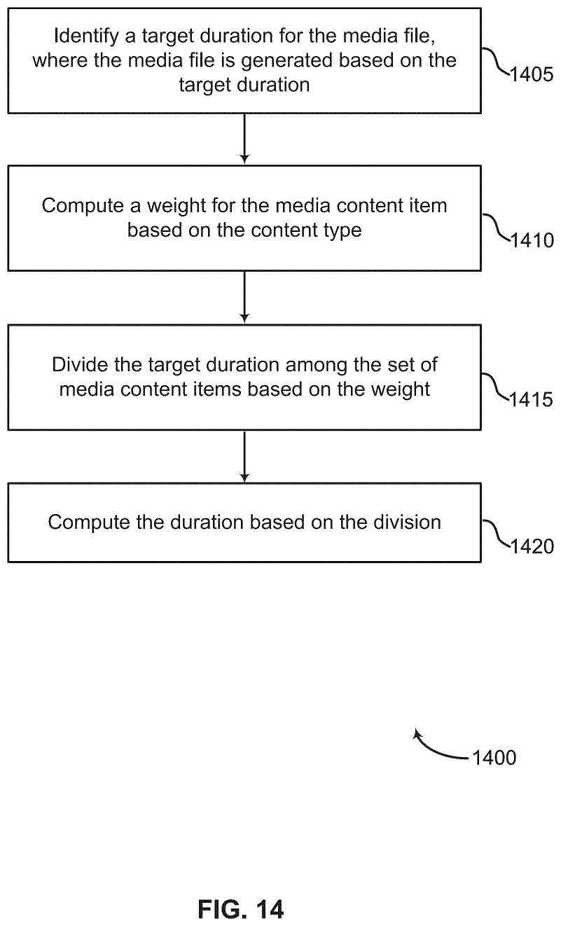

FIG. 14 shows an example of a method 1400 for media processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1405, the system identifies a target duration for the media file, where the media file is generated based on the target duration. In some cases, the operations of this step refer to, or may be performed by, a duration component as described with reference to FIG. 13. In some cases, the target duration refers to, or includes aspects of, T_{Max} as described with reference to FIG. 12. The target duration is set by a media platform to indicate a maximum length of duration when uploading a media file (e.g., videos, shorts). Different media platforms may impose different maximum (target) durations.

At operation 1410, the system computes a weight for the media content item based on the content type. In some cases, the operations of this step refer to, or may be performed by, a duration component as described with reference to FIG. 13. In some cases, the weight for the media content item refers to, or includes aspects of, w_{Graphic} or w_{Text} as described with reference to FIG. 12.

At operation 1415, the system divides the target duration among the set of media content items based on the weight. In some cases, the operations of this step refer to, or may be performed by, a duration component as described with reference to FIG. 13.

At operation 1420, the system computes the duration based on the division. In some cases, the operations of this step refer to, or may be performed by, a duration component as described with reference to FIG. 13.

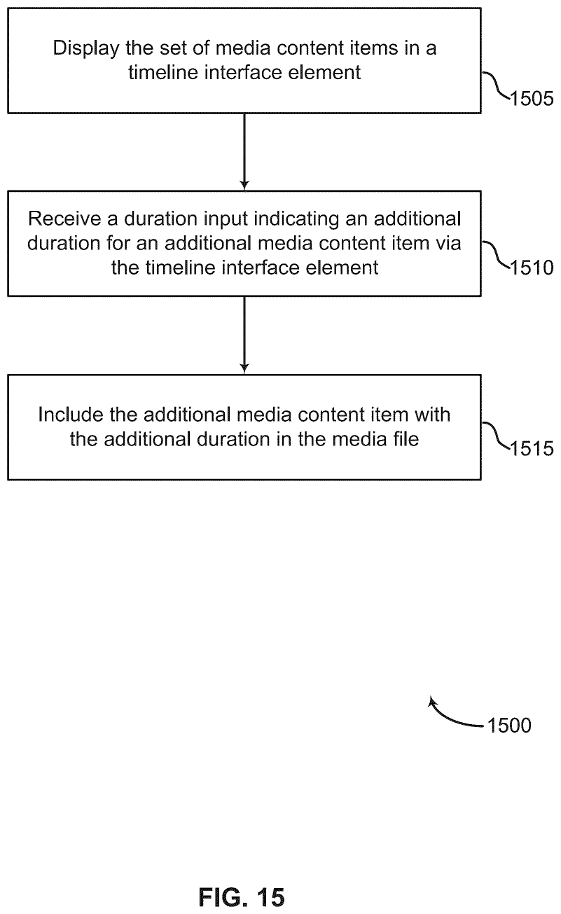

FIG. 15 shows an example of a method 1500 for media processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1505, the system displays the set of media content items in a timeline interface element. In some cases, the operations of this step refer to, or may be performed by, a timeline interface element as described with reference to FIGS. 7-9, 11, and 13.

At operation 1510, the system receives a duration input indicating an additional duration for an additional media content item via the timeline interface element. In some cases, the operations of this step refer to, or may be performed by, a timeline interface element as described with reference to FIGS. 7-9, 11, and 13.

At operation 1515, the system includes the additional media content item with the additional duration in the media file. In some cases, the operations of this step refer to, or may be performed by, a media processing model as described with reference to FIG. 13.

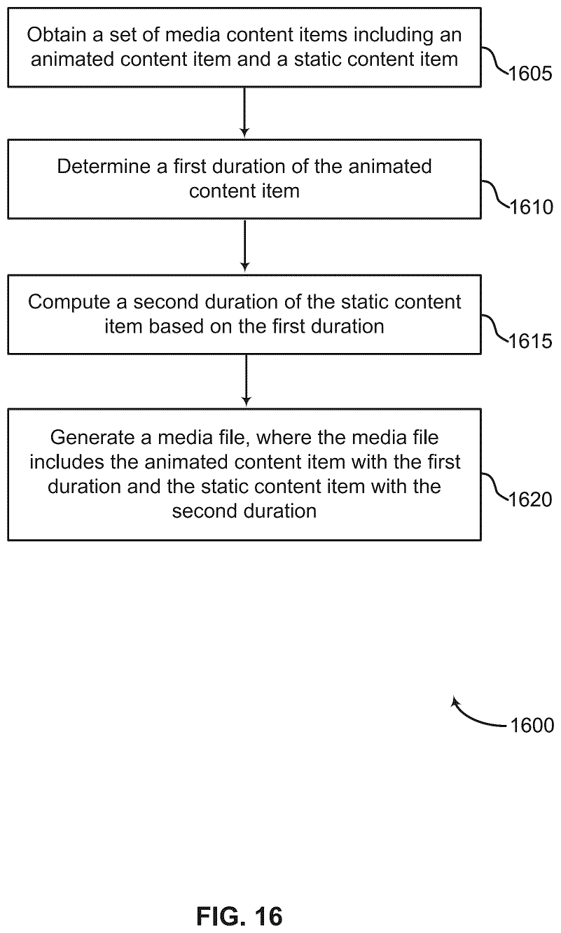

FIG. 16 shows an example of a method 1600 for media processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1605, the system obtains a set of media content items including an animated content item and a static content item. In some cases, the operations of this step refer to, or may be performed by, a media processing model as described with reference to FIG. 13.

At operation 1610, the system determines a first duration of the animated content item. In some cases, the operations of this step refer to, or may be performed by, a duration component as described with reference to FIG. 13. In some cases, the first duration of the animated content item refers to, or includes aspects of, T_{Animated} as described with reference to FIG. 12.

At operation 1615, the system computes a second duration of the static content item based on the first duration. In some cases, the operations of this step refer to, or may be performed by, a duration component as described with reference to FIG. 13. In some cases, the first duration of the animated content item refers to, or includes aspects of, T_{Static} as described with reference to FIG. 12.

At operation 1620, the system generates a media file, where the media file includes the animated content item with the first duration and the static content item with the second duration. In some cases, the operations of this step refer to, or may be performed by, a media processing model as described with reference to 13.

In FIGS. 14-16, a method, apparatus, non-transitory computer readable medium, and system for media processing are described. One or more aspects of the method, apparatus, non-transitory computer readable medium, and system include obtaining a set of media content items including an animated content item and a static content item; determining a first duration of the animated content item; computing a second duration of the static content item based on the first duration; and generating a media file, wherein the media file comprises the animated content item with the first duration and the static content item with the second duration.

Some examples of the method, apparatus, non-transitory computer readable medium, and system further include identifying a target duration for the media file, wherein the media file is generated based on the target duration.

Some examples of the method, apparatus, non-transitory computer readable medium, and system further include receiving a user input indicating a target aspect ratio, wherein the media file comprises the target aspect ratio.

Some examples of the method, apparatus, non-transitory computer readable medium, and system further include displaying the set of media content items in a timeline interface element.

FIG. 17 shows an example of a computing device 1700 for media processing according to aspects of the present disclosure. The computing device 1700 may be an example of the media processing apparatus 1300 described with reference to FIG. 13. In one aspect, computing device 1700 includes processor(s) 1705, memory subsystem 1710, communication interface 1715, I/O interface 1720, user interface component(s) 1725, and channel 1730.

In some embodiments, computing device 1700 is an example of, or includes aspects of, the media processing model of FIG. 13. In some embodiments, computing device 1700 includes one or more processors 1705 that can execute instructions stored in memory subsystem 1710 to perform media generation.

According to some aspects, computing device 1700 includes one or more processors 1705. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1715 operates at a boundary between communicating entities (such as computing device 1700, one or more user devices, a cloud, and one or more databases) and channel 1730 and can record and process communications. In some cases, communication interface 1715 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1720 is controlled by an I/O controller to manage input and output signals for computing device 1700. In some cases, I/O interface 1720 manages peripherals not integrated into computing device 1700. In some cases, I/O interface 1720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1720 or via hardware components controlled by the I/O controller.

According to some aspects, user interface component(s) 1725 enable a user to interact with computing device 1700. In some cases, user interface component(s) 1725 include an audio device, such as an external speaker system, an external display device such as a display screen, an input device (e.g., a remote-control device interfaced with a user interface directly or through the I/O controller), or a combination thereof. In some cases, user interface component(s) 1725 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a plurality of media content items;
identifying a content type of a media content item of the plurality of media content items;
computing a duration for the media content item based on the content type; and
generating a media file including the plurality of media content items, wherein the media file comprises the media content item with the computed duration.

2. The method of claim 1, further comprising:
identifying a target duration for the media file, wherein the media file is generated based on the target duration.

3. The method of claim 2, wherein identifying the target duration comprises:
receiving a user input indicating the target duration.

4. The method of claim 2, wherein computing the duration comprises:
computing a weight for the media content item based on the content type; and
dividing the target duration among the plurality of media content items based on the weight.

5. The method of claim 1, wherein computing the duration comprises:
obtaining a user profile, wherein the duration of the media content item is computed based on the user profile.

6. The method of claim 1, wherein computing the duration comprises:
obtaining a user input indicating a base duration for the plurality of media content items, wherein the duration is computed based on the base duration.

7. The method of claim 1, further comprising:
displaying the plurality of media content items in a timeline interface element.

8. The method of claim 7, further comprising:
receiving a duration input indicating an additional duration for an additional media content item via the timeline interface element, wherein the media file comprises the additional media content item with the additional duration.

9. The method of claim 1, further comprising:
computing an additional duration for an additional media content item based on the duration for the media content item, wherein the media file comprises the additional media content item with the additional duration.

10. The method of claim 9, wherein:
the content type of the media content item comprises an animated content type, and wherein the additional duration is computed after the duration based on the animated content type.

11. The method of claim 1, wherein identifying the content type comprises:
determining the content type from a set of content types including a static content type, an animated content type, a text content type, a graphic content type, an audio content type, or a combination thereof.

12. The method of claim 1, further comprising:
receiving a user input indicating a target aspect ratio, wherein the media file comprises the target aspect ratio.

13. The method of claim 1, further comprising:
obtaining a style preset; and
applying the style preset to the media content item, wherein the media file comprises the media content item with the style preset.

14. A non-transitory computer readable medium storing code for media processing, the code comprising instructions that, when executed by at least one processor, cause the at least one processor to perform operations comprising:
obtaining a plurality of media content items including an animated content item and a static content item;
determining a first duration of the animated content item;
computing a second duration of the static content item based on the first duration; and
generating a media file, wherein the media file comprises the animated content item with the first duration and the static content item with the second duration.

15. The non-transitory computer readable medium of claim 14, the code further comprising instructions executable by the at least one processor to perform operations comprising:
identifying a target duration for the media file, wherein the media file is generated based on the target duration.

16. The non-transitory computer readable medium of claim 14, the code further comprising instructions executable by the at least one processor to perform operations comprising:
receiving a user input indicating a target aspect ratio, wherein the media file comprises the target aspect ratio.

17. The non-transitory computer readable medium of claim 14, the code further comprising instructions executable by the at least one processor to perform operations comprising:
displaying the plurality of media content items in a timeline interface element.

18. A system comprising:
a memory component; and
a processing device coupled to the memory component, the processing device configured to perform operations comprising:
obtaining a plurality of media content items;
identifying a content type of a media content item of the plurality of media content items;
computing a duration for the media content item based on the content type; and
generating a media file including the plurality of media content items, wherein the media file comprises the media content item with the computed duration.

19. The system of claim 18, further comprising:
a user interface configured to obtain a user input indicating a base duration for the plurality of media content items, wherein the duration is computed based on the base duration.

20. The system of claim 18, further comprising:
a timeline interface element configured to display the plurality of media content items.
